(19) United States
(12) Patent Application Publication
(10) Pub. No.: US 2023/0373284 A1
(43) Pub. Date: Nov. 23, 2023

(54) BATTERY BOX SUPPORT FRAME, BATTERY BOX, AND ELECTRIC VEHICLE

(71) Applicants: AULTON NEW ENERGY AUTOMOTIVE TECHNOLOGY GROUP, Guangzhou, Guangdong (CN); SHANGHAI DIANBA NEW ENERGY TECHNOLOGY CO., LTD., Shanghai (CN)

(72) Inventors: Jianping Zhang, Shanghai (CN); Danliang Qiu, Shanghai (CN); Ming Li, Shanghai (CN)

(21) Appl. No.: 18/019,249

(22) PCT Filed: Aug. 4, 2021
(86) PCT No.: PCT/CN2021/110499

§ 371 Date: Jul. 31, 2023

(30) Foreign Application Priority Data
Aug. 4, 2020 (CN) 202010774081.6
Aug. 4, 2020 (CN) 202010774084.X

(51) Int. Cl. B60K 1/04; B60L 53/80; H01M 50/249; H01M 50/264; H01M 50/244

(52) U.S. Cl. CPC B60K 1/04; B60L 53/80; H01M 50/249; H01M 50/264; H01M 50/244; H01M 2220/20; B60S 5/06

(57) ABSTRACT

The battery support frame comprises a support frame body and a back panel. The support frame body has a channel for the battery box to enter into or exit from the support frame body. The back panel is used to connect the support frame body to an electric vehicle. At least one locking slot extending in an X direction is provided on the back panel. The channel for entry and exit of the battery box on the support frame body enables the support frame body to be connected to an electric vehicle by means of the back panel. The locking slot is configured to extend in the X direction, effectively increasing the area of the locking slot, and accordingly increasing the contact area between the locking slot and the locking shaft. The invention improves stress uniformity between the locking slot and the locking shaft, and prevents a concentration of stress.

This application claims the priority of Chinese patent applications 202010774084X and 2020107740816 with filing dates of Apr. 8, 2020. The contents of the above Chinese patent applications are incorporated herein by reference in their entireties.

### TECHNICAL FIELD

The present disclosure relates to the field of electric vehicles, in particular to a battery box support frame, a battery box and an electric vehicle.

### BACKGROUND

The battery box installation methods of existing electric vehicles are generally divided into fixed type and replaceable type. For an electric vehicle with a replaceable battery box, the battery box is generally mounted on the electric vehicle by means of a support frame. In order to ensure the stability of the battery box, the battery box is usually fixed on the support frame with a locking device, which can basically ensure the fixation in three directions of X\Y\Z (X: refers to a direction pointing to the front of the vehicle in a horizontal plane, Y: refers to a direction perpendicular to X in the horizontal plane; Z: refers to a height direction perpendicular to the horizontal plane). Specifically, usually several locking bases are arranged on the support frame, and locking holes are provided on the locking bases. Two opposite sides of the battery box are correspondingly provided with several locking shafts, one end of the locking shaft is connected to the battery box, and the other end of the locking shaft is inserted into the locking hole of the locking base, thereby installing the battery box to the support frame.

Since the battery box is installed to the support frame by means of the locking base and the locking shaft, in order to ensure the installation accuracy of the battery box relative to the electric vehicle, it is required to improve the installation accuracy of the locking base accordingly, and because the number of locking bases for a single electric vehicle is relatively large, it is difficult to ensure the installation accuracy of multiple locking bases, and accordingly, it is not conducive to ensuring the relative installation accuracy of the locking shaft inserted into the locking base, thus making it difficult to ensure the installation accuracy of the battery box relative to the electric vehicle.

In addition, since the locking shaft is inserted into the locking hole of the locking base, and usually the locking shaft is perpendicular to the locking base, the contact area between the locking shaft and the locking base is small, and the weight of the battery box is heavy, so the stress concentration between the locking shaft and the locking base is large, and the stress of the battery box is also concentrated, resulting in a poor stress state.

The locking device includes a locking shaft arranged on the battery box and a locking base arranged on the support frame. In general, the locking shaft of the battery box slides into the locking slot of the locking base from bottom to top along the Z direction, and then locks in place along the Y direction from the rear to the front of the vehicle, thus realizing the locking of the locking shaft relative to the locking slot, that is, realizing the installation of the battery box to the support frame of the electric vehicle.

In order to realize the circuit connection between the battery box and the electric vehicle, an electrical connection joint is usually used to connect the battery box and the electric vehicle. The electrical connection joint includes an electrical connector of the battery arranged on the battery box and an electrical connector of the vehicle arranged on the support frame. Generally, when the battery box moves from the rear of the vehicle to the front of the vehicle along the Y direction, the electrical connector of the battery on the battery box is inserted into the electrical connector of the vehicle on the support frame, thereby realizing the circuit connection between the battery box and the electric vehicle.

In order to install the battery box to the electric vehicle, it is usually necessary to ensure the accuracy of the following two installation steps in succession. First, the position of the locking shaft on the battery box relative to the locking base on the support frame is ensured first to ensure that the locking shaft can be inserted into the locking hole of the locking base. Secondly, then the position of the electrical connector of the battery on the battery box relative to the electrical connector of the vehicle on the support frame is ensured, so as to ensure that the electrical connector of the battery can be inserted into the electrical connector of the vehicle. Only in this way can the reliable installation of the battery box be realized.

It can be seen that the process of installing the battery box to the electric vehicle is complex and cumbersome, which is not conducive to the replacement of the battery box.

### CONTENT OF THE PRESENT INVENTION

The technical problem to be solved by the present disclosure is to provide a battery box support frame, a battery box and an electric vehicle in order to overcome the above-mentioned defects that the installation accuracy of the battery box is difficult to guarantee in the prior art.

The present disclosure solves the above technical problems by means of the following technical solutions:

A battery box support frame used to support and lock a battery box, the battery box support frame comprising:
a support frame body, wherein the support frame body has a channel for the battery box to enter into or exit from the support frame body along a Y direction;
a back panel, wherein the back panel is provided at one end of the support frame body, and is used to connect the support frame body to an electric vehicle, at least one locking slot extending in an X direction is provided on the back panel, and the locking slot is used to install a locking shaft of the battery box.

In this solution, by setting the channel for the battery box to enter and exit on the support frame body, the support frame body is connected to the electric vehicle by means of the back panel; the locking slot extending in the X direction is provided on the back panel, so that the locking shaft of the battery box can be installed by using the locking slot, thereby locking and fixing the battery box in a simple, efficient, and reliable manner. The locking slot is set to extend in the X direction, which can effectively increase the area of the locking slot and install the locking shaft into the locking slot, thus increasing the contact area between the locking slot and the locking shaft, improving the uniformity of the stress between the locking slot and the locking shaft, avoiding the concentration of the stress, and improving the reliability of the battery box support frame.

Preferably, the locking slot comprises an opening and an accommodating cavity which are connected, the locking shaft enters the accommodating cavity from the opening, the accommodating cavity is used for locking and fixing the locking shaft, and a bottom of the accommodating cavity is lower than a lower side surface of the opening.

In this solution, by designing the locking slot to include the opening, the locking shaft can enter into and exit from the opening more easily, and by designing the locking slot to also include the accommodation cavity, and using the accommodation cavity to fix the locking shaft, the locking shaft can be installed more stably in the accommodating cavity. The bottom of the accommodating cavity is lower than the lower side surface of the opening, so that the locking shaft can slide from the opening to the bottom of the accommodating cavity under the action of gravity, which can improve the stability and reliability of the battery box.

Preferably, at least two locking slots are arranged on the back panel at intervals in a vertical direction.

In this solution, the stability and reliability of the battery box can be further improved.

Preferably, the back panel is also provided with an electrical connector of the vehicle, and the number of the locking slots is at least two, and the locking slots are symmetrically arranged on both sides of the electrical connector of the vehicle along the X direction.

In this solution, by arranging the locking slot on both sides of the electrical connector of the vehicle, the shaking of the battery box can be reduced, and the stability and reliability of the connection of the electrical connector of the vehicle can be improved.

Preferably, the back panel has an abutting part, the abutting part protrudes from a side surface of the back panel and is used for abutting against a back wall of the battery box.

In this solution, the protruding abutting part is used for abutting against the battery box, which can prevent the locking shaft of the battery box from rotating relative to the locking slot and improve the stability and reliability of the battery box.

Preferably, a surface of the abutting part in contact with the battery box is a plane.

In this solution, the contact area between the battery box and the abutting part can be effectively increased, the stress uniformity between the battery box and the abutting part can be improved, and stress concentration can be avoided.

Preferably, the support frame body further comprises a bottom crossbeam, and the bottom crossbeam is used for supporting the battery box.

In this solution, the battery box is supported by the bottom crossbeam, which can further improve the stability and reliability of the battery box.

Preferably, the battery box support frame further comprises a locking tongue assembly, and the locking tongue assembly is used for preventing the locking shaft from moving.

In this solution, the locking tongue assembly is used to prevent the locking shaft from moving and avoid the locking shaft from moving out of the locking slot, which can improve the stability of the locking shaft, thereby improving the reliability and stability of the battery box.

Preferably, the locking tongue assembly is arranged at both ends of the locking slot.

In this solution, the locking tongue assembly acts on the locking shaft at both ends of the locking slot, which can further improve the stability of the locking shaft and also improve the reliability and stability of the battery box.

Preferably, an electrical connection socket is also provided on the back panel, and the locking slots are provided on both sides of the electrical connection socket, when the locking shaft slides into the locking slot, an electrical connection plug of the battery box is inserted into the electrical connection socket.

In this solution, when the locking shaft slides into the locking slot, the electrical connection plug of the battery box is inserted into the electrical connection socket, so that the installation of the battery box and the connection between the battery box and the electric vehicle can be completed simultaneously, which can improve the efficiency of the battery box installation.

By arranging the locking slots on both sides of the electrical connection socket, the shaking of the battery box can be reduced, and the stability and reliability of the connection of the electrical connection socket can be improved.

Preferably, a side of the back panel facing the battery box is provided with an electrical connector of the vehicle and a locking slot, the electrical connector of the vehicle is used for electrically connecting an electrical connector of the battery on the battery box, and the locking slot is used for locking the battery box. The locking slot comprises a locking section, the locking section is used for limiting the movement of the battery box along the Y direction so as to fix the battery box on the support frame body, and when the locking shaft of the battery box is located at the locking section, the electrical connector of the vehicle is electrically connected to the electrical connector of the battery.

In this solution, by setting the channel for the battery box to enter and exit on the support frame body, the support frame body is connected to the electric vehicle by means of the back panel; the locking slot including the locking section and the electrical connector of the vehicle are set on the back panel, and at the same time, the battery box is provided with the locking shaft and the electrical connector of the battery, so that the battery box can be installed to the locking section of the locking slot by means of the locking shaft to realize the locking and fixation of the battery box relative to the electric vehicle, which can improve the stability and reliability of the battery box. While the battery box is locked and fixed, the electrical connector of the vehicle is electrically connected with the electrical connector of the battery, so that the installation of the battery box and the connection between the battery box and the electric vehicle can be completed at the same time, and the efficiency of battery box installation can be improved.

Preferably, the locking slot includes an opening section, the opening section is connected to the locking section, and the locking section is located below the opening section.

In this solution, by designing the locking slot to include an opening, the locking shaft can enter and exit the opening more easily, and by designing the locking slot to also include the locking section, and using the locking section to fix the locking shaft, the locking shaft can be more stably installed in the locking section. The bottom of the locking section is lower than the lower side surface of the opening, so that the locking shaft can slide from the opening to the bottom of the locking section under the action of gravity, thereby improving the stability and reliability of the battery box.

Preferably, the locking slot further comprises a transition ramp, the opening section is connected to the locking section by the transition ramp.

In this solution, the transition ramp enables the locking shaft to slide smoothly from the plane of the opening to the bottom of the locking section.

Preferably, the battery box support frame assembly further comprises a first positioning unit, the first positioning unit is used for positioning the battery box in the process of moving towards the battery box support frame assembly along the Y direction.

In this solution, the position accuracy of the battery box relative to the battery box support frame can be ensured, thus improving the controllability and safety of the battery box installation process.

Preferably, the first positioning unit includes a detection point, the detection point is set on the back panel, and the battery box is provided with a first detection element. In the process of the battery box moving towards the battery box support frame assembly along the Y direction, the first detection element detects the detection point to realize Y-direction positioning of the locking shaft of the battery box and the locking slot on the back panel;
and/or, the detection point is provided on the battery box and the first detection element is provided on the back panel.

In this proposal, by setting the detection point and setting the detection point at one or two of the back panel or the battery box; at the same time, correspondingly setting the first detection element at one or two of the back panel or the battery box, in the process of the battery box moving towards the battery box support frame assembly along the Y direction, the phase positions of the locking shaft and the locking slot of the battery box in the Y direction can be accurately detected, and thus the controllability and safety of the battery box installation process can be further improved.

Preferably, the battery box support frame assembly further comprises a second positioning unit, and the second positioning unit is used for positioning the electrical connector of the battery and the electrical connector of the vehicle.

In this solution, the accuracy of the position of the electrical connector of the battery relative to the electrical connector of the vehicle can be ensured, thus improving the controllability and safety during the installation of the battery box.

Preferably, the second positioning unit comprises a positioning sleeve and a positioning column, the positioning sleeve is arranged on the electrical connector of the battery, and the positioning column is arranged on the electrical connector of the vehicle, and when the locking shaft enters the opening section of the locking slot, the positioning column is inserted into the positioning sleeve.

In this solution, the second positioning unit is designed to include the positioning sleeve and the positioning column, which are provided on the electrical connector of the battery and the electrical connector of the vehicle respectively, and when the locking shaft enters the opening section of the locking slot, the positioning column is inserted into the positioning sleeve, so as to realize the relative positioning of the electrical connector of the battery to the electrical connector of the vehicle, and thus ensuring the accurate connection between the electrical connector of the battery and the electrical connector of the vehicle.

Preferably, when the locking shaft enters the locking section along the locking slot, the positioning column enables positioning of the electrical connector of the battery in the Y direction and/or a Z direction relative to the electrical connector of the vehicle along the positioning sleeve, realizing the electrically connection between the electrical connector of the battery and the electrical connector of the vehicle.

In this solution, the locking shaft enters the locking section of the locking slot, thus achieving locking and fixation of the battery box relative to the support frame body. At the same time, the positioning column and the positioning sleeve are plugged in place to realize the positioning of the electrical connector of the battery relative to one or two of the Y direction and the Z direction of the electrical connector of the vehicle, thereby realizing the electrical connection between the electrical connector of the battery and the electrical connector of the vehicle. This solution can simultaneously realize the fixation of the battery box relative to the support frame body and the electrical connection between the battery box and the electric vehicle, which effectively improves the efficiency and reliability of installing the battery box to the electric vehicle.

Preferably, the number of the locking slots is at least two, and different locking slots are arranged on both sides of the electrical connector of the vehicle;
and/or, the number of the locking slots is at least two, and the different locking slots are arranged at intervals along the Z direction on the back panel.

In this solution, the area of the locking slot can be effectively increased, and the locking shaft is installed into the locking slot, which can increase the contact area between the locking slot and the locking shaft, improve the stress uniformity between the locking slot and the locking shaft, avoid the concentration of the stress, and improve the reliability of the battery box support frame assembly.

Preferably, the battery box support frame assembly further includes a locking tongue, and the locking tongue is rotatably arranged in the locking slot, the locking tongue is used to prevent the locking shaft from moving.

In this solution, the locking tongue is used to prevent the locking shaft from moving and prevent the locking shaft from moving out of the locking slot, which can improve the stability of the locking shaft and thus can improve the reliability and stability of the battery box.

Preferably, the locking tongue are arranged at both ends of the locking slot extending along the X direction.

In this solution, the locking tongue acts on the locking shaft at both ends of the locking slot, which can further improve the stability of the locking shaft and also improve the reliability and stability of the battery box.

Preferably, the battery box support frame assembly further comprises a ball bushing, and the ball bushing is rotatably sleeved on the locking shaft.

In this solution, the friction when the locking shaft slides into the locking slot can be reduced, which improves the stability and reliability of the battery box.

A battery box, wherein the battery box includes a locking shaft and a box body, the locking slot is arranged on a side surface of the box body, the locking shaft extends along an X direction, and the locking shaft is used for clamping into the locking slot of the battery box support frame as described above.

In this solution, by providing the locking shaft extending in the X direction, the locking shaft can be installed into the locking slot, and the contact area between the locking slot and the locking shaft can also be increased, which improves the uniformity of the stress between the locking slot and the locking shaft, avoids the concentration of stress, and improves the reliability of the battery box installation.

An electric vehicle comprising the battery box support frame as described above and the battery box as described above.

In this solution, the stability of the battery box in the battery box support frame can be improved, and the movement of the battery box in the battery box support frame can be restricted, thereby improving the reliability and safety of the electric vehicle.

On the basis of conforming to common knowledge in the field, the above-mentioned preferred conditions can be combined arbitrarily to obtain preferred examples of the present disclosure.

The positive improved effects of the present disclosure are that:
in the present disclosure, by setting the channel for the battery box to enter and exit on the support frame body, the support frame body is connected to the electric vehicle by means of the back panel; the locking slot extending in the X direction is provided on the back panel, so that the locking shaft of the battery box can be installed by using the locking slot, thereby locking and fixing the battery box in a simple, efficient, and reliable manner. The locking slot is set to extend in the X direction, which can effectively increase the area of the locking slot and install the locking shaft into the locking slot, thus increasing the contact area between the locking slot and the locking shaft, improving the uniformity of the stress between the locking slot and the locking shaft, avoiding the concentration of the stress, and improving the reliability of the battery box support frame;
the locking slot including the locking section and the electrical connector of the vehicle are set on the back panel, and at the same time, the battery box is provided with the locking shaft and the electrical connector of the battery, so that the battery box can be installed to the locking section of the locking slot by means of the locking shaft to realize the locking and fixation of the battery box relative to the electric vehicle, which can improve the stability and reliability of the battery box. While the battery box is locked and fixed, the electrical connector of the vehicle is electrically connected with the electrical connector of the battery, so that the installation of the battery box and the connection between the battery box and the electric vehicle can be completed at the same time, and the efficiency of battery box installation can be improved.

### BRIEF DESCRIPTION OF THE DRAWINGS

FIG. 1 is a schematic structural diagram of a battery box support frame installed with a battery box according to embodiment 1 of the present disclosure.

FIG. 2 is a schematic structural diagram of the battery box support frame in FIG. 1.

FIG. 3 is a partially enlarged structural schematic diagram of the battery box support frame in FIG. 2.

FIG. 4 is a schematic structural diagram of the battery box support frame in FIG. 2 viewed from above.

FIG. 5 is a structural schematic diagram of a section of the battery box support frame in FIG. 2.

FIG. 6 is a schematic structural diagram of the battery box in FIG. 1.

FIG. 7 is a schematic structural diagram of the section A-A in FIG. 1.

FIG. 8 is a schematic structural diagram of a battery box support frame assembly according to embodiment 2 of the present disclosure.

FIG. 9 is a schematic structural diagram of a support frame body in FIG. 8.

FIG. 10 is a schematic structural diagram of the support frame body in FIG. 9 viewed from above.

FIG. 11 is a schematic structural diagram of the battery box in FIG. 8.

FIG. 12 is a structural schematic diagram of a section of the battery box support frame assembly when a locking shaft reaches an opening section in FIG. 8.

FIG. 13 is a structural schematic diagram of a section of the battery box support frame assembly when the locking shaft enters the opening section in FIG. 8.

FIG. 14 is a structural schematic diagram of a section of the battery box support frame assembly when the locking shaft enters a transition ramp in FIG. 8.

FIG. 15 is a structural schematic diagram of a section of the battery box support frame assembly when the locking shaft enters a locking section in FIG. 8.

### DESCRIPTION OF REFERENCE NUMERALS

### Embodiment 1

Battery box support frame 100; support frame body 11; back panel 12; locking slot 121; opening 122; accommodating cavity 123; abutting part 124; transition ramp 125; electrical connector of the vehicle 13; locking tongue assembly 14; lock fastener 141; drive end 142; first recessed portion 143; second recessed portion 144; protrusion 145; first pivot point 146; second pivot point 147; limit part 148; connecting member 149; electrical connection socket 15; battery box 200; locking shaft 21; electrical connection plug 22; box body 23.

### Embodiment 2

Battery box support frame assembly 100; support frame body 11; back panel 12; locking slot 121; opening section 122; locking section 123; abutting part 124; transition ramp 125; electrical connector of the vehicle 13; positioning column 131; locking tongue 14; battery box 200; locking shaft 21; electrical connector of the battery 22; positioning sleeve 221; box body 23.

### DETAILED DESCRIPTION OF THE PREFERRED EMBODIMENT

The present disclosure is further more clearly and completely illustrated below by means of embodiments and in conjunction with the accompanying drawings, but the present disclosure is not limited to the scope of the examples.

### Embodiment 1

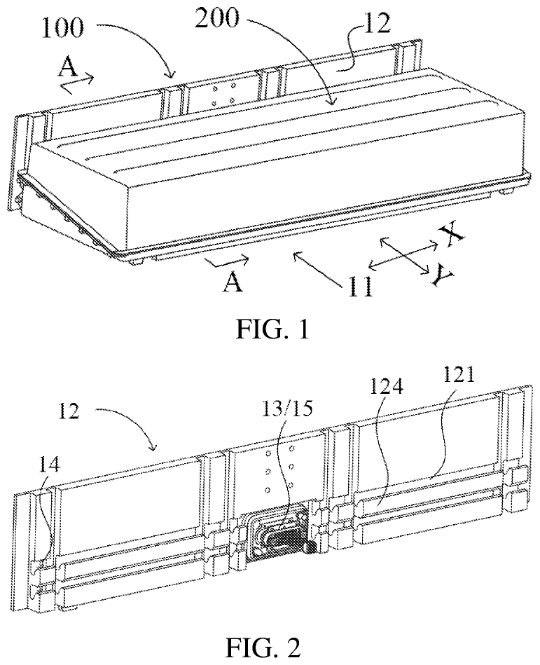

As shown in FIGS. 1-7, this embodiment may be an electric vehicle, and the electric vehicle comprises a battery box support frame 100 as follows and a battery box 200 as follows. This embodiment can improve the stability of the battery box 200 within the battery box support frame 100 and limit the movement of the battery box 200 within the battery box support frame 100, thus improving the reliability and safety of the electric vehicle.

As shown in FIGS. 1-6, this embodiment is a battery box support frame 100, which is used to support and lock the battery box 200. The battery box support frame 100 includes: a support frame body 11 and a back panel 12, and the support frame body 11 has a channel for the battery box 200 to enter into and exit from the support frame body 11 along a Y direction; the back panel 12 is provided at one end of the support frame body 11 for connecting the support frame body 11 to an electric vehicle. The back panel 12 is provided with at least one locking slot 121 extending in an X direction, and the locking slot 121 is used to install a locking shaft 21 of the battery box 200. By setting the channel for the battery box 200 to enter and exit on the support frame body 11, the support frame body 11 is connected to the electric vehicle by means of the back panel 12; the locking slot 121 extending in the X direction is provided on the back panel 12, so that the locking shaft 21 of the battery box 200 can be installed by using the locking slot 121, thereby locking and fixing the battery box 200 in a simple, efficient, and reliable manner. Setting the locking slot 121 to extend in the X direction can effectively increase the area of the locking slot 121 and install the locking shaft 21 into the locking slot 121, thus can increase the contact area between the locking slot 121 and the locking shaft 21, improve the uniformity of the stress between the locking slot 121 and the locking shaft 21, avoid the concentration of the stress, and improve the reliability of the battery box support frame 100.

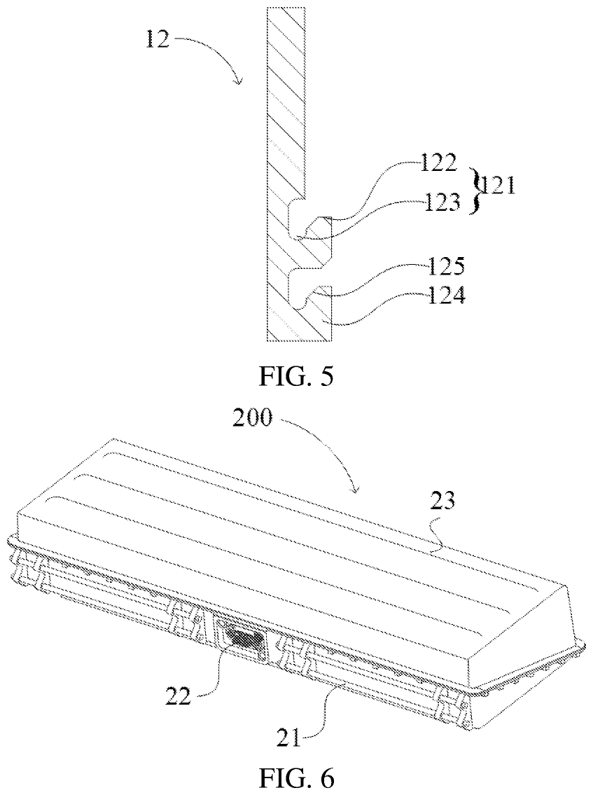

As shown in FIG. 5, the locking slot 121 includes an opening 122 and an accommodating cavity 123 which are connected. The locking shaft 21 enters the accommodating cavity 123 from the opening 122, the accommodating cavity 123 is used for locking and fixing the locking shaft 21, and a bottom of the accommodating cavity 123 is lower than a lower side surface of the opening 122. By designing the locking slot 121 to include the opening 122, the locking shaft 21 can enter and exit the opening 122 more easily, and by designing the locking slot 121 to also include the accommodating cavity 123, and using the accommodating cavity 123 to fix the locking shaft 21, the locking shaft 21 can be installed more stably in the accommodating cavity 123. The bottom of the accommodating cavity 123 is lower than the lower side surface of the opening 122, so that the locking shaft 21 can slide from the opening 122 to the bottom of the accommodating cavity 123 under the action of gravity, which can improve the stability and reliability of the battery box 200.

As an embodiment, the opening 122 may be a plane, and an inner side surface of the bottom of the accommodating cavity 123 matches an outer peripheral surface of the locking shaft 21. The locking shaft 21 may be a cylinder, and correspondingly, the cross-section of the bottom may be an arc surface, and the arc surface matches the outer peripheral surface of the cylinder. A transition ramp 125 may also be provided between the plane of the opening 122 and the arc surface of the bottom, and the transition ramp 125 can make the locking shaft 21 slide smoothly from the plane of the opening 122 to the bottom of the accommodating cavity 123. The transition ramp 125 may be an inclined surface, and an included angle between the inclined surface and the vertical surface may be 45° or 60°.

As shown in FIGS. 2 and 5, at least two locking slots 121 are arranged on the back panel 12 at intervals along a vertical direction. The at least two locking slots 121 can further improve the stability and reliability of the battery box 200. In other embodiments, the number of the locking slot 121 may also be one.

As shown in FIG. 2, the back panel 12 is also provided with an electrical connector of the vehicle 13, the number of the locking slots 121 is at least two, and the locking slots 121 are symmetrically arranged on both sides of the electrical connector of the vehicle 13 along the X direction. By arranging the locking slot 121 on both sides of the electrical connector of the vehicle 13, the shaking of the battery box 200 can be reduced, and the stability and reliability of the connection of the electrical connector of the vehicle 13 can be improved.

As shown in FIGS. 2-5, the back panel 12 has an abutting part 124 protruding from a side surface of the back panel 12, and the abutting part 124 is used to abut against a back wall of the battery box 200. Utilizing the protruding abutting part 124 to abut against the battery box 200 can prevent the locking shaft 21 of the battery box 200 from rotating relative to the locking slot 121, thereby improving the stability and reliability of the battery box 200.

In FIG. 5, a surface of the abutting part 124 in contact with the battery box 200 is a plane. The contact area between the battery box 200 and the abutting portion 124 can be effectively increased, the stress uniformity between the battery box 200 and the abutting portion 124 can be improved, and stress concentration can be avoided.

In other embodiments, the support frame body 11 further comprises a bottom crossbeam for supporting the battery box 200. Utilizing the bottom crossbeam to support the battery box 200 can further improve the stability and reliability of the battery box 200. The bottom crossbeam can also be provided with a roller sleeve, the roller sleeve can be rotated, and the battery box 200 is set on an upper side surface of the roller sleeve. When the battery box 200 enters the support frame body 11, the roller sleeve rotates under the drive of the battery box 200, which can reduce the friction of the battery box 200 sliding into the support frame body 11. As an embodiment, the back panel 12 may also be connected to the bottom crossbeam, and the back panel 12 is set at one end of the bottom crossbeam.

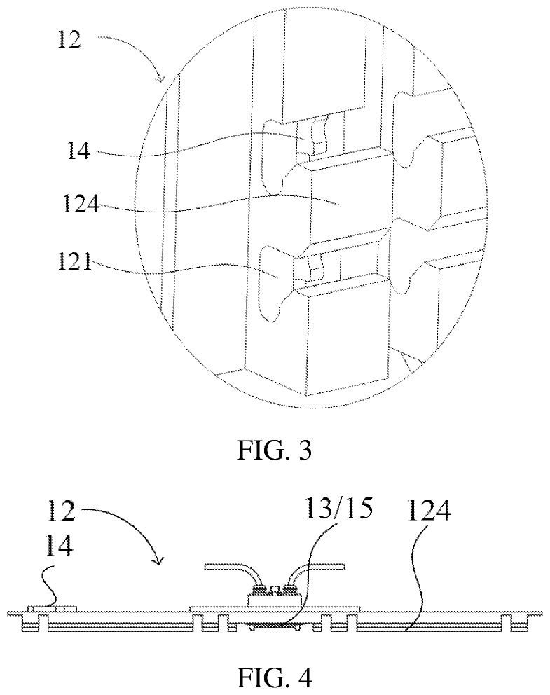

As shown in FIG. 3 and FIG. 4, the battery box support frame 100 further includes a locking tongue assembly 14 for preventing the locking shaft 21 from moving. Utilizing the locking tongue assembly 14 to prevent the locking shaft 21 from moving and avoid the locking shaft 21 from moving out of the locking slot 121 can improve the stability of the locking shaft 21, thereby improving the reliability and stability of the battery box 200. As a preferred embodiment, the locking tongue assembly 14 is arranged at both ends of the locking slot 121. The locking tongue assembly 14 acts on the locking shaft 21 at both ends of the locking slot 121, which can further improve the stability of the locking shaft 21 and also improve the reliability and stability of the battery box 200. As an embodiment, the locking tongue assembly 14 is capable of catching the locking shaft 21 located within the locking slot 121, thereby preventing the locking tongue 21 from moving out of the locking slot 121. When the locking shaft 21 needs to be moved out of the locking slot 121, the locking tongue assembly 14 may be moved away from the locking shaft 21 so that the locking shaft 21 can exit the locking slot 121.

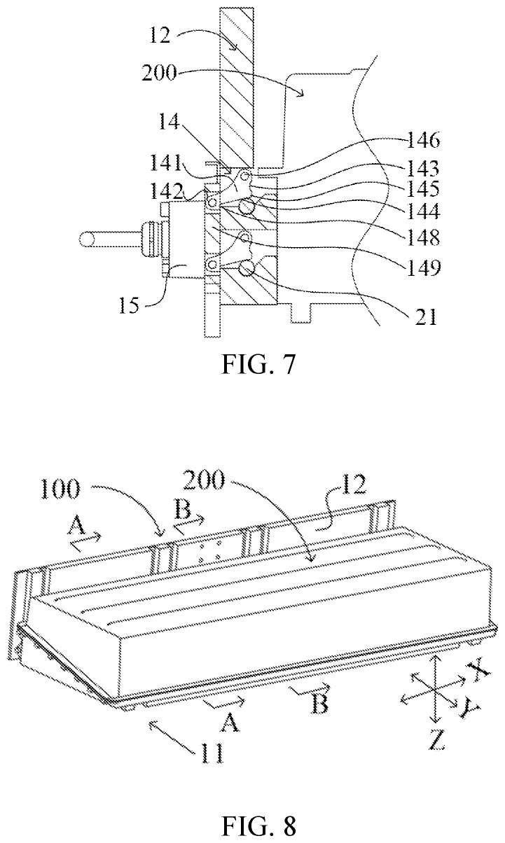

As shown in FIG. 7, which shows the state where the locking shaft 21 of the battery box 200 is located in the accommodating cavity 123 of the locking slot 121. At this time, the locking tongue assembly 14 prevents the locking shaft 21 from moving. The locking tongue assembly 14 in FIG. 7 includes a lock fastener 141 and a connecting member 149. The lock fastener 141 is pivotally attached to the battery box 200 support frame 100 at a first pivot point 146. A first end of the connecting member 149 is pivotally attached to one end of the lock fastener 141, and a second end of the connecting member 149 extends (downward) toward a bottom surface of the battery box support frame 100. The connecting member 149 drives the lock fastener 141 to rotate clockwise around the first pivot point 146 to unlock the battery box 200 under the action of an external force, and the connecting member 149 drives the lock fastener 141 to rotate counterclockwise around the pivot point under no external force to prevent the locking shaft 21 of the battery box 200 from leaving the locking slot 121.

The lock fastener 141 in FIG. 7 has a first pivot point 146 and a second pivot point 147, where at the first pivot point 146, the lock fastener 141 is connected to the back panel 12, and at the second pivot point 147, the lock fastener 141 is connected to the connecting member 149. The first pivot point 146 is disposed on the right of the second pivot point 147. When the battery box 200 is locked, the first pivot point 146 is higher than the second pivot point 147.

The lock fastener 141 in FIG. 7 has a first recessed portion 143, a protrusion 145 and a second recessed portion 144. The first recessed portion 143 is close to the first pivot point 146, the second recessed portion 144 is close to the second pivot point 147, and the protrusion 145 is formed between the first recessed portion 143 and the second recessed portion 144. When the battery box 200 is disassembled, the lock fastener 141 is rotated clockwise and the locking shaft 21 is removed from the locking slot 121. The first recessed portion 143 is used to avoid the locking shaft 21, so that the locking shaft 21 of the battery box 200 leaves the locking slot 121 more smoothly. When the battery box 200 is installed, the lock fastener 141 is rotated counterclockwise to a locking position as shown in FIG. 7, at which time the locking shaft 21 is located in the locking slot 121 and the second recessed portion 144 is located above the locking slot 121 to form a space to accommodate the locking shaft 21. Optionally, the second recessed portion 144 may also be omitted if the locking slot 121 itself has sufficient accommodating space. The protrusion 145 is disposed between the first recessed portion 143 and the second recessed portion 144 to prevent the locking shaft 21 from moving over the locking slot 121 to the left when the lock fastener 141 moves to the unlocking position and to prevent the locking shaft 21 from disengaging from the locking slot 121 toward the right side above the locking slot 121 when the lock fastener 141 moves to the locking position.

As shown in FIG. 2, FIG. 4 and FIG. 6, the back panel 12 is also provided with an electrical connection socket 15, and both sides of the electrical connection socket 15 are provided with the locking slot 121. When the locking shaft 21 slides into the locking slot 121, an electrical connection plug 22 of the battery box 200 is inserted into the electrical connection socket 15. When the locking shaft 21 slides into the locking slot 121, the electric connection plug 22 of the battery box 200 is inserted into the electric connection socket 15, thus enabling the installation of the battery box 200 and the connection of the battery box 200 to the electric vehicle to be completed simultaneously, which can improve the efficiency of the installation of the battery box 200. By setting the locking slot 121 on both sides of the electrical connection socket 15, the shaking of the battery box 200 can be reduced and the stability and reliability of the electrical connection socket 15 connection can be improved.

As shown in FIG. 6, this embodiment is a battery box 200. The battery box 200 includes a locking shaft 21 and a box body 23, and a locking slot 121 is provided on a side surface of the box body 23. The locking shaft 21 extends along the X direction, and the locking shaft 21 is used to clamp into the locking slot 121 of the battery box support frame 100 as described above. By providing the locking shaft 21 extending along the X direction, the locking shaft 21 can be installed into the locking slot 121, and the contact area between the locking slot 121 and the locking shaft 21 can also be increased, which improves the uniformity of the stress between the locking slot 121 and the locking shaft 21, avoids the concentration of the stress, and improves the reliability of the battery box 200 installation.

In order to reduce the friction of the locking shaft 21 sliding into the locking slot 121, a ball bushing may also be sleeved on the outer periphery of the locking shaft 21, and the ball bushing is rotatable with respect to the locking shaft 21. The locking shaft 21 is installed in the locking slot 121 by means of the ball bushing, which can reduce the friction when the locking shaft 21 slides into the locking slot 121 and improve the stability and reliability of the battery box 200.

### Embodiment 2

As shown in FIGS. 8-11, this embodiment is a battery box support frame assembly 100 (i.e., battery box support frame) for supporting and locking a battery box 200. The battery box support frame assembly 100 includes a support frame body 11 and a back panel 12, the support frame body 11 has a channel for the battery box 200 to enter into and exit from the battery box support frame assembly 100 in a Y direction; the back panel 12 is provided at one end of the support frame body 11, and the back panel 12 is used to connect the support frame body 11 to an electric vehicle. A side of the back panel 12 facing the battery box 200 is provided with an electrical connector of the vehicle 13 and a locking slot 121. The electrical connector of the vehicle 13 is used for electrically connecting an electrical connector of the battery 22 on the battery box 200, and the locking slot 121 is used to lock the battery box 200. The locking slot 121 includes a locking section 123, the locking section 123 is used to limit the movement of the battery box 200 along the Y direction, so that the battery box 200 is fixed on the support frame body 11, and when the locking shaft 21 of the battery box 200 is located at the locking section 123, the electrical connector of the vehicle 13 is electrically connected with the electrical connector of the battery. By setting the channel for the battery box 200 to enter and exit on the support frame body 11, the support frame body 11 is connected to the electric vehicle by means of the back panel 12; the locking slot 121 including the locking section 123 and the electrical connector of the vehicle 13 are set on the back panel 12, and at the same time, the battery box 200 is provided with the locking shaft 21 and the electrical connector of the battery 22, so that the battery box 200 can be installed to the locking section 123 of the locking slot 121 by means of the locking shaft 21 to achieve the locking and fixing of the battery box 200 relative to the electric vehicle, which can improve the stability and reliability of the battery box 200. While the battery box 200 is locked and fixed, the electrical connector of the vehicle 13 is electrically connected to the electrical connector of the battery 22, so that the installation of the battery box 200 and the connection between the battery box 200 and the electric vehicle can be completed at the same time, which can improve the efficiency of the battery box 200 installation.

As shown in FIG. 5 in the first embodiment, the locking slot 121 includes an opening section 122, the opening section 122 is connected to the locking section 123, and the locking section 123 is located below the opening section 122. By designing the locking slot 121 to include the opening section 122, the locking shaft 21 can enter and exit the opening section 122 more easily, and by designing the locking slot 121 to also include the locking section 123, and using the locking section 123 to fix the locking shaft 21, the locking shaft 21 can be more stably installed to the locking section 123. The bottom of the locking section 123 is lower than the lower side surface of the opening section 122, so that the locking shaft 21 can slide from the opening section 122 to the bottom of the locking section 123 under the action of gravity, which can improve the stability and reliability of the battery box 200.

In FIG. 5, the locking slot 121 further includes a transition ramp 125, and the opening section 122 is connected to the locking section 123 by the transition ramp 125. The transition ramp 125 enables the locking shaft 21 to slide smoothly from the plane of the opening section 122 to the bottom of the locking section 123.

As an embodiment, the opening section 122 may be a plane and an inner side surface of the bottom of the locking section 123 matches an outer peripheral surface of the locking shaft 21. The locking shaft 21 may be a cylinder, and correspondingly, the cross-section of the bottom may be an arc surface, and the arc surface matches the outer peripheral surface of the cylinder. The transition ramp 125 may also be provided between the plane of the opening section 122 and the arc surface of the bottom, the transition ramp 125 can make the locking shaft 21 slide smoothly from the plane of the opening section 122 to the bottom of the locking section 123. The transition ramp 125 may be an inclined surface, and the included angle between the inclined surface and the vertical surface may be 45°.

As a preferred embodiment, the battery box support frame assembly 100 further includes a first positioning unit, which is used for positioning the battery box 200 in the process of moving towards the battery box support frame assembly 100 along the Y direction. The position accuracy of the battery box 200 relative to the battery box support frame assembly 100 can be ensured, thereby improving the controllability and safety of the battery box 200 during installation.

Specifically, the first positioning unit includes a detection point, the detection point is set on the back panel 12, the battery box 200 is provided with a first detection element. In the process of the battery box 200 moving towards the battery box support frame assembly 100 along the Y direction, the first detection element detects the detection point to realize Y-direction positioning of the locking shaft 21 of the battery box 200 and the locking slot 121 on the back panel 12; correspondingly, the detection point may also be set on the battery box 200 simultaneously or separately, and the first detection element is set on the back panel 12. By setting the detection point and setting the detection point on one or two of the back panel 12 or the battery box 200; at the same time, correspondingly setting the first detection element on one or two of the back panel 12 or the battery box 200, in the process of the battery box 200 moving towards the battery support frame assembly along the Y direction, the phase positions of the locking shaft 21 of the battery box 200 and the locking slot 121 in the Y direction can be accurately detected, thereby further improving the controllability and safety of the battery box 200 during installation. As an embodiment, the first positioning unit may include a laser ranging sensor or an infrared ranging sensor.

As a preferred embodiment, the battery box support frame assembly 100 further includes a second positioning unit for positioning the electrical connector of the battery 22 and the electrical connector of the vehicle 13. The position accuracy of the electrical connector of the battery 22 relative to the electrical connector of the vehicle 13 can be ensured, thereby further improving the controllability and safety of the battery box 200 during installation.

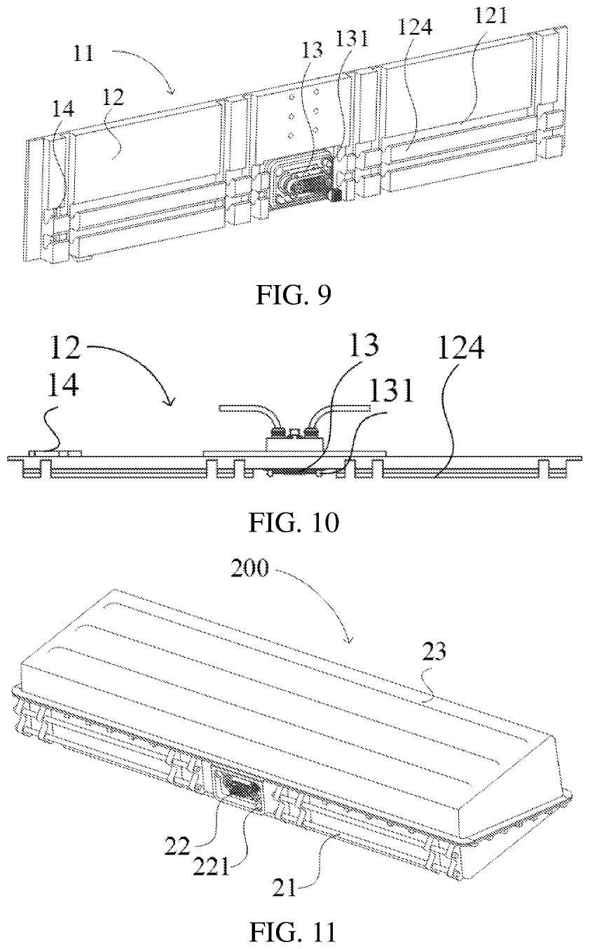

As shown in in FIGS. 9, 10 and 11, the second positioning unit includes a positioning sleeve 221 and a positioning column 131. The positioning sleeve 221 is arranged on the electrical connector of the battery 22, and the positioning column 131 is arranged on the electrical connector of the vehicle 13. When the locking shaft 21 enters the opening section 122 of the locking slot 121, the positioning column 131 is inserted into the positioning sleeve 221. By designing the second positioning unit to include the positioning sleeve 221 and the positioning column 131, which are respectively arranged on the electrical connector of the battery 22 and the electrical connector of the vehicle 13, and when the locking shaft 21 enters the opening section 122 of the locking slot 121, the positioning column 131 is inserted into the positioning sleeve 221, so that the relative positioning of the battery-side electrical connector 22 relative to the vehicle-side electrical connector 13 can be realized, thus ensuring the accurate connection between the electrical connector of the battery 22 and the electrical connector of the vehicle 13.

In order to improve the efficiency and reliability of the installation of the battery box 200, when the locking shaft 21 enters the locking section 123 along the locking slot 121, the positioning column 131 enables the positioning of the electrical connector of the battery 22 relative to the electrical connector of the vehicle 13 in one or two of the Y direction and the Z direction along the positioning sleeve 221 to realize the electrical connection between the electrical connector of the battery 22 and the electrical connector of the vehicle 13. The locking shaft 21 enters the locking section 123 of the locking slot 121, so as to realize locking and fixing of the battery box 200 relative to the support frame body 11. At the same time, the positioning column 131 and the positioning sleeve 221 are inserted in place to realize the positioning of the electrical connector of the battery 22 relative to the electrical connector of the vehicle 13 in one or two of the Y direction and the Z direction, thus realizing the electrical connection between the electrical connector of the battery 22 and the electrical connector of the vehicle 13. This embodiment can simultaneously achieve the fixation of the battery box 200 relative to the support frame body 11 and the electrical connection between the battery box 200 and the electric vehicle, effectively improving the efficiency and reliability of the battery box 200 installation to the electric vehicle.

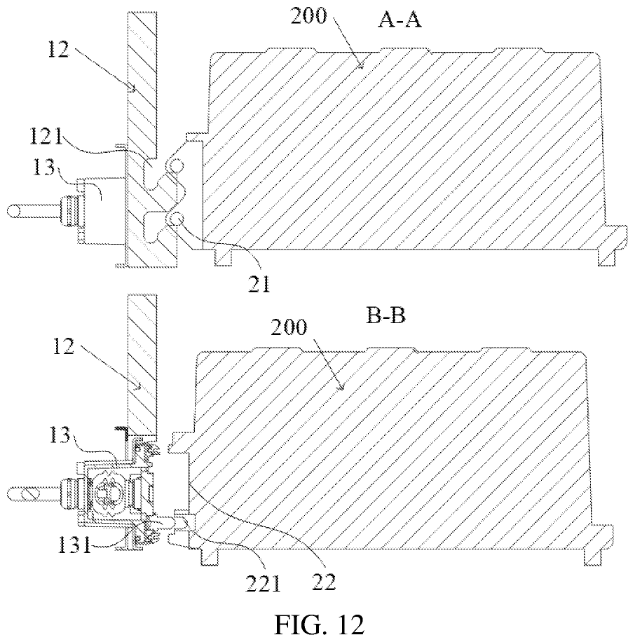

As a specific embodiment, the process of installing the battery box 200 to the back panel 12 is shown in FIGS. 12-15. The housing of the electrical connector of the vehicle 13 in the figure is fixedly connected to the back panel 12. The electrical connector of the vehicle 13 is provided with the positioning column 131, which is floatingly connected to the housing of the electrical connector of the vehicle 13, such that the positioning column 131 can be moved in X, Y, and Z directions relative to the housing of the electrical connector of the vehicle 13. The end of the positioning column 131 also has a guide inclined plane which can guide the positioning column 131 to be inserted into the positioning sleeve 221 on the electrical connector of the battery 22. For illustration purposes, the section B-B in the figure shows the positioning column 131 and the positioning sleeve 221, and does not show the other components of the electrical connector of the vehicle 13 and the electrical connector of the battery 22 in detail.

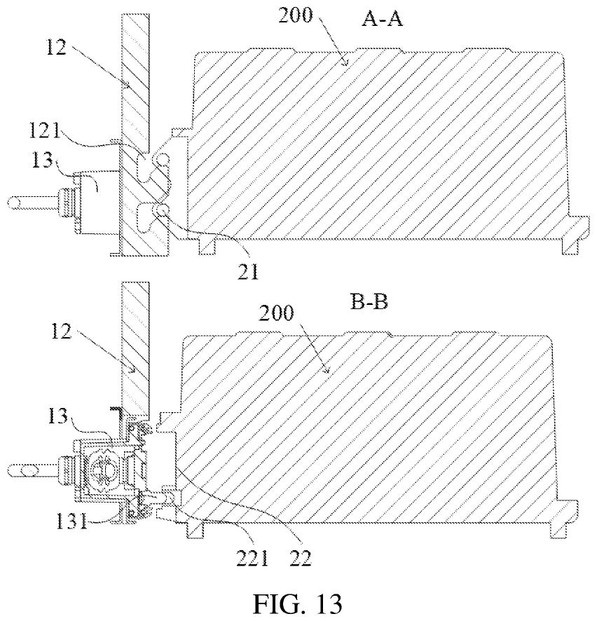

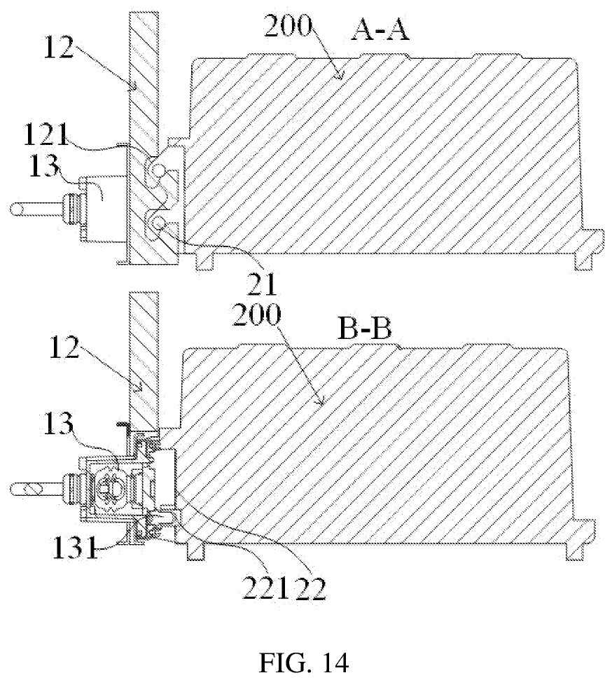

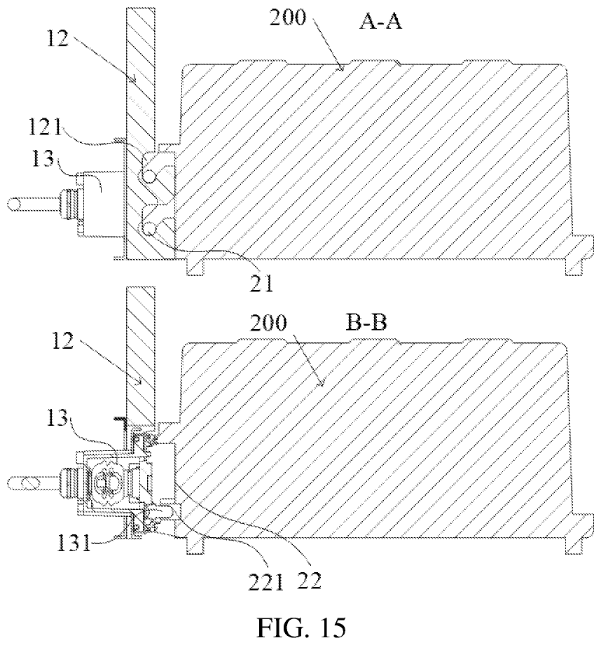

As shown in section A-A in FIG. 12, the locking shaft 21 of the battery box 200 is about to reach the opening section 122 of the locking slot 121, at which point the positioning column 131 is not inserted into the positioning sleeve 221 as shown in section B-B in FIG. 12. As the battery box 200 approaches the back panel 12 in the Y direction, as shown in the section A-A in FIG. 13, when the locking shaft 21 enters the opening section 122 of the locking slot 121, as shown in the section B-B in FIG. 13, the positioning column 131 is inserted into the positioning sleeve 221, at this time the centers of the positioning column 131 and the positioning sleeve 221 do not coincide, and there is an angular deviation between the two, so as to realize the positioning of the electrical connector of the battery 22 relative to the electrical connector of the vehicle 13. The battery box 200 continues to approach the back panel 12 along the Y direction, as shown in the section A-A in FIG. 14. The locking shaft 21 slides into the transition ramp 125 from the opening section 122, at this time, as shown in the section B-B in FIG. 14, the positioning column 131 is further inserted into the positioning sleeve 221. Due to the floating connection of the positioning column 131 relative to the housing of the electrical connector of the vehicle 13, the positioning column 131 can self-adapt to the angular deviation from the positioning sleeve 221, so that the positioning column 131 can continue to be inserted into the positioning sleeve 221. The battery box 200 continues to slide along the transition ramp 125 and slides to the locking section 123, as shown in section A-A in FIG. 15, and the locking shaft 21 reaches the locking section 123 to achieve locking and fixation of the locking shaft 21 relative to the locking slot 121. At this time, as shown in the section B-B in FIG. 15, the positioning column 131 is completely inserted into the positioning sleeve 221, and at this time, the centers of the positioning column 131 and the positioning sleeve 221 coincide, and the electrical connection between the electrical connector of the battery 22 and the electrical connector of the vehicle 13 is realized at the same time.

In this embodiment, on the one hand, by means of the first positioning unit, the rough positioning of the locking shaft 21 and the locking slot 121, and the positioning sleeve 221 and the positioning column 131 in the Y direction are realized. When the locking shaft 21 reaches the opening section 122 of the locking slot 121, there is a certain angular deviation between the centers of the positioning column 131 and the positioning sleeve 221. During the process of the locking shaft 21 entering the locking slot 121, the guide inclined plane at the end of the positioning column 131 guides the positioning sleeve 221 to continue to be inserted along the Y direction. At the same time, because the positioning column 131 may float in X, Y and Z directions, the positioning column 131 can be adaptively inserted into the positioning sleeve 221. When the locking shaft 21 reaches the locking section 123 in the locking slot 121, the centers of the positioning column 131 and the positioning sleeve 221 coincide, thus realizing the positioning connection of the electrical connector of the vehicle 13 and the electrical connector of the battery 22 in the X, Y and Z directions.

As an embodiment, the number of the locking slots 121 is at least two, and different locking slots 121 are provided on both sides of the electrical connector of the vehicle 13; this embodiment may also design the number of locking slots 121 to be at least two at the same time or separately, and different locking slots 121 are provided on the back panel 12 at intervals along the Z-direction. This embodiment can effectively increase the area of the locking slot 121 and install the locking shaft 21 into the locking slot 121, which can increase the contact area between the locking slot 121 and the locking shaft 21, improve the uniformity of the stress between the locking slot 121 and the locking shaft 21, avoid the concentration of the stress, and improve the reliability of the battery box support frame assembly 100.

As shown in FIG. 9 and FIG. 10, the battery box support frame assembly 100 also includes a locking tongue 14, which is rotatably provided in the locking slot 121, and the locking tongue 14 is used to prevent the locking shaft 21 from moving. Utilizing the locking tongue 14 to prevent the locking shaft 21 from moving and avoid the locking shaft 21 from moving out of the locking slot 121 can improve the stability of the locking shaft 21, thereby improving the reliability and stability of the battery box 200.

As shown in FIG. 9 and FIG. 10, the locking slot 121 extends along the X-direction of the back panel 12, and the locking tongue 14 is provided at both ends of the locking slot 121 extending along the X-direction. The locking tongue 14 acts on the locking shaft 21 at both ends of the locking slot 121, which can further improve the stability of the locking shaft 21, and also improve the stability and reliability of the battery box 200.

In order to reduce friction, the battery box support frame assembly 100 also includes a ball bushing, which is rotatably sleeved on the locking shaft 21, which can reduce the friction of the locking shaft 21 when sliding into the locking slot 121 and improve the stability and reliability of the battery box 200.

As shown in FIGS. 9-12, the back panel 12 has an abutting part 124 protruding from the side surface of the back panel 12, and the abutting part 124 is used to abut against the back wall of the battery box 200. Utilizing the protruding abutting part 124 to abut against the battery box 200 can prevent the locking shaft 21 of the battery box 200 from rotating relative to the locking slot 121, thereby improving the stability and reliability of the battery box 200.

In FIG. 5, the surface of the abutting part 124 in contact with the battery box 200 is a plane, which can effectively increase the contact area between the battery box 200 and the abutting part 124, improve the uniformity of the stress between the battery box 200 and the abutting part 124, and avoid the concentration of the stress.

In other embodiments, the support frame body 11 may further comprise a bottom crossbeam for supporting the battery box 200. Utilizing the bottom crossbeam to support the battery box 200 can further improve the stability and reliability of the battery box 200. The bottom crossbeam may also be provided with a roller sleeve, the roller sleeve may be rotated, and the battery box 200 is set on an upper side surface of the roller sleeve. When the battery box 200 enters the support frame body 11, the roller sleeve rotates under the drive of the battery box 200, which can reduce the friction of the battery box 200 sliding into the support frame body 11.

Although the specific implementation of the present disclosure has been described above, those skilled in the art should understand that this is only an example, and that a variety of changes or modifications to these embodiments can be made without departing from the principles and substance of the present disclosure. Accordingly, the scope of protection of the present disclosure is limited by the appended claims.

1. A battery box support frame used to support and lock a battery box, wherein the battery box support frame comprises:
a support frame body, wherein the support frame body has a channel for the battery box to enter into or exit from the support frame body along a Y direction;
a back panel, wherein the back panel is provided at one end of the support frame body, and is used to connect the support frame body to an electric vehicle, at least one locking slot extending in an X direction is provided on the back panel, and the locking slot is used to install a locking shaft of the battery box.

2. The battery box support frame according to claim 1, wherein the locking slot comprises an opening and an accommodating cavity which are connected, the locking shaft enters the accommodating cavity from the opening, the accommodating cavity is used for locking and fixing the locking shaft, and a bottom of the accommodating cavity is lower than a lower side surface of the opening.

3. The battery box support frame according to claim 1, wherein at least two locking slots are arranged on the back panel at intervals in a vertical direction;
preferably, the back panel is also provided with an electrical connector, and the number of the locking slots is at least two, and the locking slots are symmetrically arranged on both sides of the electrical connector along the X direction.

4. The battery box support frame according to claim 1, wherein the back panel has an abutting part, the abutting part protrudes from a side surface of the back panel and is used for abutting against a back wall of the battery box;
preferably, a surface of the abutting part in contact with the battery box is a plane.

5. The battery box support frame according to claim 1, wherein the support frame body further comprises a bottom crossbeam, and the bottom crossbeam is used for supporting the battery box.

6. The battery box support frame according to claim 1, wherein the battery box support frame further comprises a locking tongue assembly, and the locking tongue assembly is used for preventing the locking shaft from moving;
preferably, the locking tongue assembly is arranged at both ends of the locking slot.

7. The battery box support frame according to claim 1, wherein an electrical connection socket is also provided on the back panel, and the locking slots are provided on both sides of the electrical connection socket, when the locking shaft slides into the locking slot, an electrical connection plug of the battery box is inserted into the electrical connection socket.

8. The battery box support frame according to claim 1, wherein a side of the back panel facing the battery box is provided with an electrical connector of the vehicle, which is used for electrically connecting an electrical connector of the battery on the battery box, and the locking slot comprises a locking section, the locking section is used for limiting the movement of the battery box along the Y direction so as to fix the battery box on the support frame body, and when the locking shaft of the battery box is located at the locking section, the electrical connector of the vehicle is electrically connected to the electrical connector of the battery.

9. The battery box support frame assembly according to claim 8, wherein the locking slot comprises an opening section, the opening section is connected to the locking section, and the locking section is located below the opening section;
preferably, the locking slot further comprises a transition ramp, the opening section is connected to the locking section by the transition ramp.

10. The battery box support frame according to claim 8, wherein the battery box support frame further comprises a first positioning unit, the first positioning unit is used for positioning the battery box in the process of moving towards the battery box support frame along the Y direction.

11. The battery box support frame according to claim 10, wherein the first positioning unit comprises a detection point, the detection point is set on the back panel, and the battery box is provided with a first detection element, in the process of the battery box moving towards the battery box support frame assembly along the Y direction, the first detection element detects the detection point to realize Y-direction positioning of the locking shaft of the battery box and the locking slot on the back panel;
and/or, the detection point is provided on the battery box and the first detection element is provided on the back panel.

12. The battery box support frame according to claim 8, wherein the battery box support frame assembly further comprises a second positioning unit, and the second positioning unit is used for positioning the electrical connector of the battery and the electrical connector of the vehicle.

13. The battery box support frame according to claim 12, wherein the second positioning unit comprises a positioning sleeve and a positioning column, the positioning sleeve is arranged on the electrical connector of the battery, and the positioning column is arranged on the electrical connector of the vehicle, and when the locking shaft enters the opening section of the locking slot, the positioning column is inserted into the positioning sleeve.

14. The battery box support frame according to claim 13, wherein when the locking shaft enters the locking section along the locking slot, the positioning column enables positioning of the electrical connector of the battery in the Y direction and/or a Z direction relative to the electrical connector of the vehicle along the positioning sleeve, realizing the electrically connection between the electrical connector of the battery and the electrical connector of the vehicle.

15. The battery box support frame according to claim 8, wherein the number of the locking slots is at least two, and different locking slots are arranged on both sides of the electrical connector of the vehicle;
and/or, the number of the locking slots is at least two, and the different locking slots are arranged at intervals along the Z direction on the back panel.

16. The battery box support frame according to claim 8, wherein the battery box support frame assembly further comprises a locking tongue, and the locking tongue is rotatably arranged in the locking slot, the locking tongue is used to prevent the locking shaft from moving.

17. The battery box support frame according to claim 16, wherein the locking tongue are arranged at both ends of the locking slot extending along the X direction.

18. The battery box support frame according to claim 8, wherein the battery box support frame assembly further comprises a ball bushing, and the ball bushing is rotatably sleeved on the locking shaft.

19. A battery box, wherein the battery box comprises a locking shaft and a box body, the locking slot is arranged on a side surface of the box body, the locking shaft extends along an X direction, and the locking shaft is used for clamping into the locking slot of the battery box support frame according to claim 1.

20. An electric vehicle, comprising the battery box support frame according to claim 1 and the battery box, and the battery box comprises the locking shaft and a box body, the locking slot is arranged on a side surface of the box body, the locking shaft extends along the X direction, and the locking shaft is used for clamping into the locking slot of the battery box support frame.
